(19) United States
(12) Patent Application Publication
(10) Pub. No.: US 2005/0039537 A1
(43) Pub. Date: Feb. 24, 2005

(54) Isochoric volumeter

(76) Inventors: Ole Mejlhede Jensen, Aalborg Ost (DK); Per Freiesleben Hansen, Roskilde (DK); Kirsten Hojst Hansen, Solrod Strand (DK)

Correspondence Address: James C Wray, Suite 300, 1493 Chain Bridge Road, McLean, VA, 22101, US

(21) Appl. No.: 10/483,673

(22) PCT Filed: Jul. 11, 2002
(86) PCT No.: PCT/DK02/00484

(30) Foreign Application Priority Data
Jul. 13, 2001 (DK) PA 2001 01105

(51) Int. Cl. G01L 7/16

(52) U.S. Cl. 73/744

(57) ABSTRACT

The invention concerns an apparatus and a method for continuous measuring volumetric flow rates or volume changes in a material that undergoes physical, chemical-physical and/or chemical processes. The apparatus is constructed with a reference chamber which is connected to a test chamber, and means for maintaining a selected pressure in the reference chamber, as well as means for regulating the temperature in the reference chamber.

### BACKGROUND

The present invention concerns an apparatus for continuous measurement of volume flow rates or volume changes in materials that undergo physical, physical-chemical and/or chemical reactions. Furthermore, the invention concerns a method for this continuous measurement.

Measuring the so-called chemical shrinkage of cement systems during hydration plays a central role, particularly by a research-related description of the hydrating kinetics of Portland cement. Within the last decades, concrete technologic developments have formed the basis of a new concept: high quality concrete (High-Performance-Concrete). Where in conventional concrete typically a water/cement ratio (w/c-ratio) in the range 0.40-0.60 has been used, modern super-plasticizing additives have today enabled production of low-viscosity concretes which—with simultaneous addition of up to 20% micro silica—have a w/c ratio of 0.20-0.30. This new concept means that today one is working with binder phases with extremely low permeability; this development has given rise to completely new requirements to the measuring technique used in research.

During hydration of Portland cement, which mainly consists of the clinker minerals 3CaOSiO₂, 2CaOSiO₂, 3CaOAl₂O₃, and 4CaOAl₂O₃Fe₂O₃, a number of hydrates are formed, influencing the properties of the formed binder phase in different ways. For all hydrating reactions it is the case that the reaction products formed have a smaller volume than the transformed reactants. This means that hydrating reactions are connected with a reduction in volume, a chemical shrinkage. For Portland cement, the chemical shrinkage during hydration is typically of the magnitude 6 cm₃ per 100 g transformed cement.

The size of this chemical shrinkage in particular depends on which hydrate types are formed during hydration. A continuous measuring of the chemical shrinkage during the hydration of the cement system therefore contain essential information about the properties of the cement, about the course and character of the hydrate formation, and through this reflects the influence of different operating conditions during the hydration reaction.

### Technical Measuring Problem

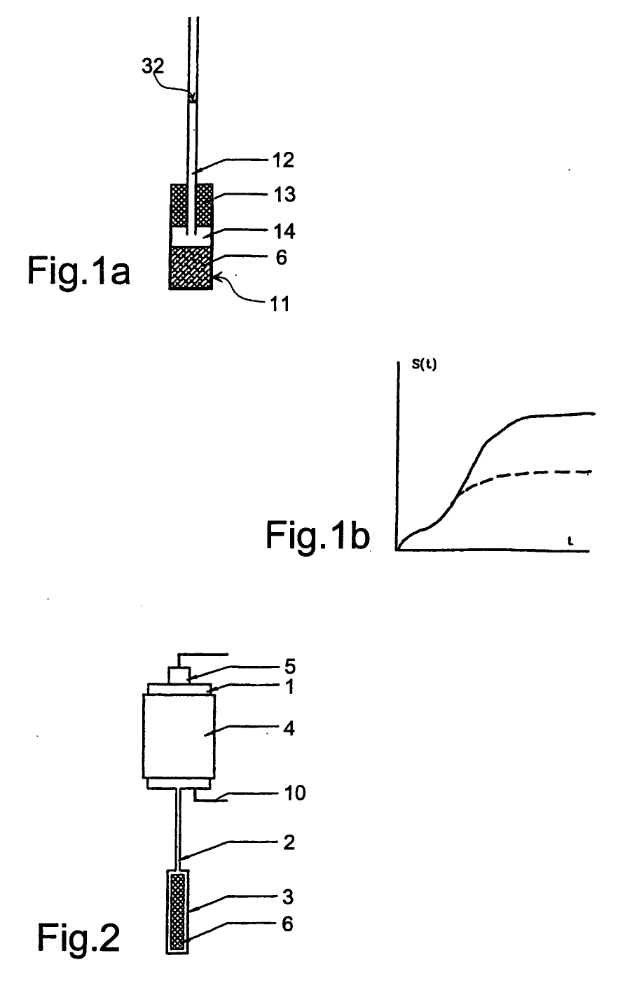

Chemical shrinkage during the hydration of a cement may in principle be measured in a set-up as shown in FIG. 1a. The specimen 6 of cement paste to be examined is placed in a test container 11, the container being tightly closed with a stopper 13. In the test container 11, besides the specimen water 14 is present, and a water-filled riser pipe 12 is connected through the stopper 13. During the hydration, the specimen 6 will suck an amount of water corresponding to the chemical shrinkage during the hydration; the chronological development of the shrinkage may thereby be determined by reading the lowering of the surface 37 as a function of time, h(t), in a calibrated riser pipe.

The measurement may in principle be executed with a set-up as shown on FIG. 1a. A specimen is placed in a test holder connected to a water-filled riser pipe. During the hydration, the specimen will suck an amount of water corresponding to the chemical shrinkage during the hydration, see FIG. 1b. The chronological development of the shrinkage, S(t), may hereby be determined. By measuring binder phases in high quality concretes, however, the low permeability prevents the sucking of water from the surroundings in an early stage of the hydration; this has the consequence that gas-filled pores are formed in the hardening cement paste.

This basically simple measuring principle has hitherto been used in various set-ups for surveying the reaction kinetics of conventional cement systems.

By examining reaction progress in binder phases of modem high quality concretes, a simple measuring set-up as shown in FIG. 1a fails. The technical measuring problem is based on the permeability of the binder phase through addition of micro silica and lowering of the w/c-ratio being drastically reduced. Even by low degrees of hydration the suction of water from the surroundings is blocked; the chemical shrinkage instead leads to formation of internal gas-filled pores in the hydrating binder phase (see dashed line in FIG. 1).

This problem may be solved with regard to the measuring technique by:
the dimension H of the test level is reduced, whereby the specimen volume is reduced. This means, all things being equal, that requirements for the accuracy of the volume measurement are increased;
that the driving pressure differential, which in the simple measuring set-up in FIG. 1a is the atmospheric pressure, is increased so that formation of internal gas-filled pores is counteracted.

Since these requirements may be fulfilled only with difficulty by the measuring principle drafted in FIG. 1, there is thus a need for design, development and testing of a new principle for accurate, continuous measurement of chemical shrinkage, S(t), in hardening binder phases of high quality concrete.

The present invention solves the above problem by a method which is peculiar in providing a method for continuous measuring of volume changes in materials that are subjected to physical, physical-chemical and/or chemical reactions with an apparatus including a test chamber and a reference chamber, the chambers being mutually connected, and where means for detecting the pressure in a liquid placed in the reference chamber is provided in the reference chamber, and means for temperature regulation and temperature detection are furthermore provided in the reference chamber, where the pressures in the reference chamber and the test chamber are known, where the temperature is measured in a reference liquid contained in the reference chamber, and where temperature changes of the reference liquid in the reference chamber are correlated with corresponding volume changes of a specimen contained in the test chamber.

In this way, by utilising the physical relations between volume changes and associated temperature changes is achieved a particularly accurate and unequivocal method for determining volume changes in the materials. Furthermore, this method, as opposed to prior art, is very well suited for detecting the continuing change of volume.

Furthermore, the invention provides a method for continuing measurement of volume flow rates to or from materials that are subjected to physical, physical-chemical and/or chemical reactions with an apparatus including a test chamber and a reference chamber, the chambers being mutually connected, and where means for detecting the pressure in a liquid placed in the reference chamber is provided in the reference chamber, and means for temperature regulation and temperature detection in the liquid placed in the reference chamber are furthermore provided, where the pressures in the reference chamber and the test chamber are known, where the temperature is measured in a reference liquid contained in the reference chamber, and where temperature changes of the reference liquid in the reference chamber are correlated with corresponding volume flow rates of a specimen liquid between a test chamber and the surroundings for the test chamber, and where the specimen liquid is contained in the test chamber and/or the surroundings.

On the same basic principles valid for volume changes, volume flow rates in materials may correspondingly continuously be determined very accurately in a corresponding manner by detecting the physical relationship between liquid flow rates and associated temperature changes in a system with constant pressure.

In a further, preferred embodiment of the invention, the volumetric flows are one or more of the following types of flow: laminar flow, turbulent flow, capillary flow, diffusion, and/or osmosis. The physical laws, upon which the measuring principle of the invention are based, may all detect the volume flow rates as a consequence of the above mentioned types of flow. Hereby it is ensured that the method will be applicable for a large number of volume flows in different materials.

In a further, preferred embodiment of the invention, the pressure in the reference chamber and in the test chamber are maintained at one and the same level, where the pressure in the reference chamber and in the test chamber is regulated by regulating the temperature in the reference chamber, and where a change in volume of a specimen in the test chamber is reflected by a change in temperature in the reference chamber so that a reduction in volume of the specimen in the test chamber is reflected in a rise in temperature in the reference chamber, and an increased volume of the specimen in the test chamber is reflected in a drop of temperature in the reference chamber.

Since the pressure in the test chamber and in the reference chamber changes very slowly due to the physical, physical-chemical and/or chemical reactions in the specimen material, even a moderate heating or cooling, respectively, of the liquid may ensure that the pressure in the chambers is kept constant. As the temperature is relatively simple to control, and furthermore may be controlled very precisely, this is a very simple way in which to keep the pressure constant. The rise and drop in pressure, respectively, will thus indicate changes in volume in the specimen.

In a still further embodiment of a method according to the invention, the pressure in the reference chamber and the test chamber are maintained at one and the same level, where the pressure in the reference chamber and in the test chamber is regulated by regulating the temperature of the liquid in the reference chamber, and where a volume flow rate of specimen liquid to or from the test chamber is reflected in a change in temperature in the test chamber so that a volume flow rate of specimen liquid in the test chamber is reflected in a rise in temperature in the reference chamber, and a volume flow rate of specimen liquid to the test chamber is reflected in a drop of temperature in the reference chamber.

The same principles are valid for volume flow rates as for volume reductions, since the variation in temperature in the medium will reflect variations in the pressure in the chambers. As described above, the same mechanisms and the same advantages achieved thereby will thus appear.

The invention also provides an apparatus for continuous measurement of volume flow rates or volume changes in materials that undergo physical, physical-chemical and/or chemical reactions, the apparatus being peculiar in that the apparatus includes a test chamber and a reference chamber that are mutually connected, where a specimen is arranged in the test chamber during measurements, and test chamber, reference chamber and their mutual connection are filled with a liquid, and where the pressure in the test chamber during measurements is the same as the pressure in the reference chamber, where the reference chamber is provided with a pressure transducer for measuring the pressure in the reference chamber, and where the reference chamber is also provided with a temperature regulator intended for regulating the temperature of the liquid in the reference chamber, and where the reference chamber is also provided with means for detecting temperature changes in the liquid in the reference chamber.

Thus the apparatus is provided with the necessary means for detecting pressure differences and adjusting the temperature in order to provide a pressure in the reference chamber corresponding to the pressure in the test chamber. By detecting the pressure in this way and by compensating correspondingly by a change in temperature, the volume flow rate or the volume changes may be detected very accurately and continuously.

In a further, preferred embodiment of the apparatus, the test chamber and the reference chamber are mutually connected with a tube, preferably a capillary tube, so that a largely thermal separation of the liquid in the reference chamber and in the test chamber is achieved, and so that a pressure connection between the reference chamber and the test chamber is ensured.

By this arrangement of the apparatus, the accuracy becomes even greater as a possible heat generation in the test chamber will not have any influence on the conditions in the reference chamber. The heat generation will only appear as an increase in pressure which will be detected in the reference chamber.

In a further, preferred embodiment of the apparatus, the pressure in the test chamber and in the reference chamber, respectively, will be regulated by changing the temperature of the liquid in the reference chamber.

In a further, preferred embodiment, the specimen liquid in the test chamber is the same liquid as the reference liquid in the reference chamber, and the liquids further have the possibility of pressure equalisation between the specimen liquid and the reference liquid, and the liquids also have the possibility of exchanging the liquids between the test chamber and the reference chamber, respectively.

For materials bonded by cement, the liquid will typically be water, which makes it is simple to place a specimen in the apparatus and then to fill the cavities in the test chamber and the reference chamber with water. Since water furthermore is approximately incompressible at pressures used during the measurements, an efficient pressure equalisation and thereby detection of the shrinkage will thereby be achieved.

The apparatus may also, in a further preferred embodiment, be adapted so that the specimen liquid in the test chamber is different from the reference liquid in the reference chamber, and that there is the possibility of pressure equalisation between the specimen liquid and the reference liquid, though means have been arranged for preventing mixing of the liquids in the test chamber and the reference chamber, respectively.

This embodiment may be particularly interesting where the liquid may have a detrimental influence on the specimen, e.g. by washing out or dissolving parts of the specimen. Thus, by combining two different liquids, there is provided for the need for not decomposing the specimen or damage it in other ways and simultaneously utilising some pressure and heat capacity properties of a different liquid in the reference chamber. The means for preventing mixing of the liquid in the test chamber and the reference chamber may be selected depending on the kind of liquid in question. The means for preventing mixing may e.g. consist of a spherical body or a cylindrical body placed in the connecting tube between the two chambers.

In a further, preferred embodiment, a membrane is provided between the liquids in the test chamber and the reference chamber, respectively, where the membrane has a flexibility that ensures sufficient possibility for pressure equalisation between the liquids in the test chamber and the reference chamber, and where the membrane also has a tightness that ensures sufficient prevention of mixing the liquid in the test chamber and the reference chamber, respectively.

By arranging a membrane, mixing of the liquids is effectively prevented as well as the flexibility of the membrane ensures that an efficient pressure equalisation will take place between the test chamber and the reference chamber.

In order to make the apparatus usable for a wide range of measurements, in a further preferred embodiment the apparatus may be adapted so that one or more of the parameters measurement range, pressure level, solubility limit, and time constant for the apparatus may be adapted to specific applications of measurement and use by establishing given measures for one or more of the terms: volume of the test chamber, volume of the reference chamber, the shape of the reference chamber, and the measuring range of the pressure transducer.

The apparatus according to the invention is particularly developed for use in connection with measuring volume changes caused by physical and/or chemical and/or physical/chemical reactions, e.g. by measuring chemical shrinkage in cement-based materials, including particularly for measuring chemical shrinkage in dense binder phases in high-strength concrete for determining hydration kinetics in the materials.

### TECHNICAL MEASURING PRINCIPLE

The principle and structure of the invention will now be described in detail with reference to the accompanying drawings, where:

FIG. 1a shows a prior art measuring set-up,

FIG. 1b shows the shrinking process associated with 1a,

FIG. 2 shows a schematic drawing of an apparatus according to the invention,

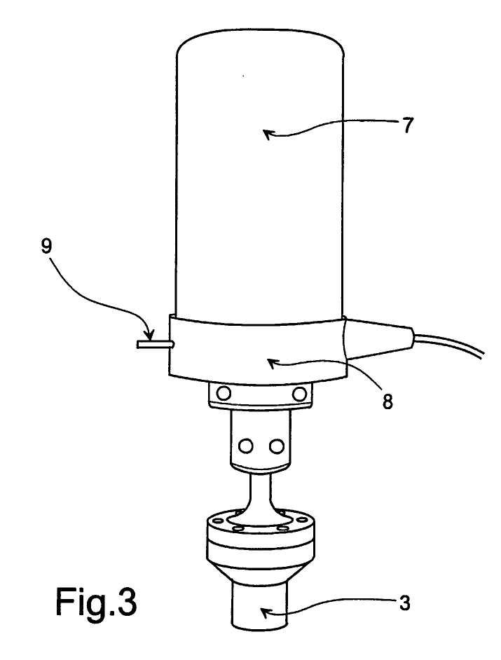

FIG. 3 shows an example of an actual embodiment,

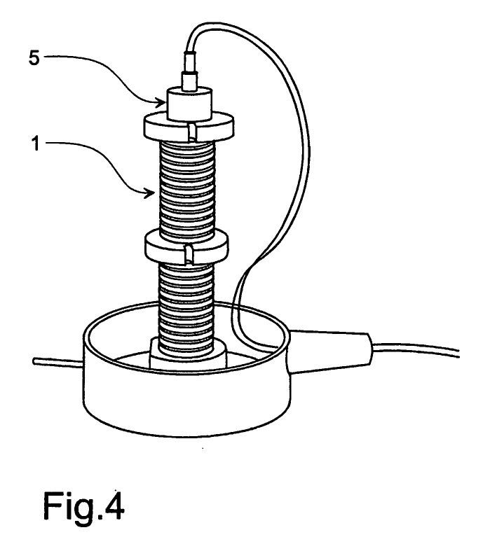

FIG. 4 shows a detail of the apparatus,

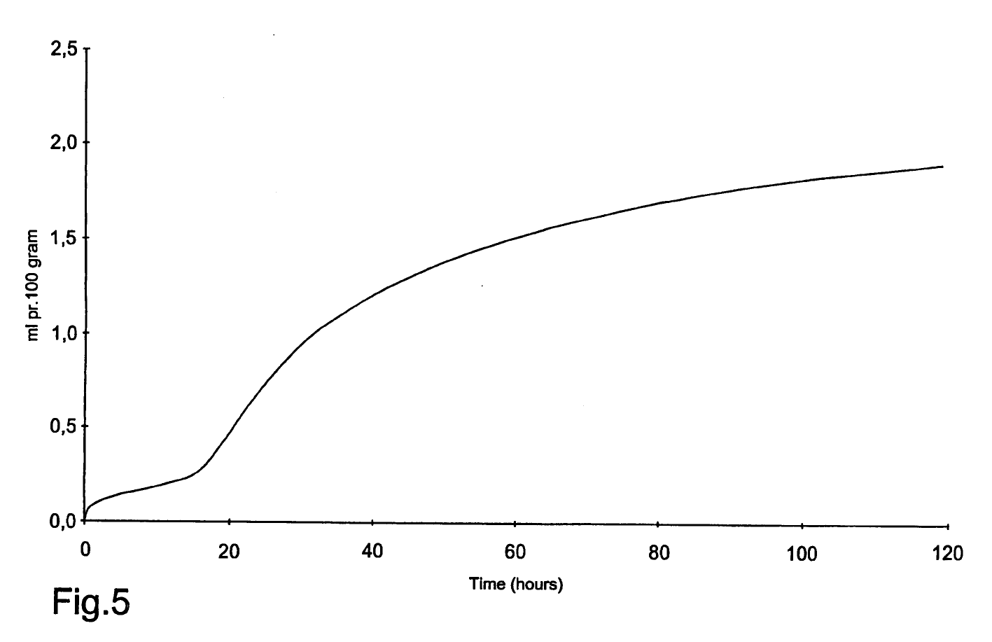

FIG. 5 illustrates a typical shrinkage process, and

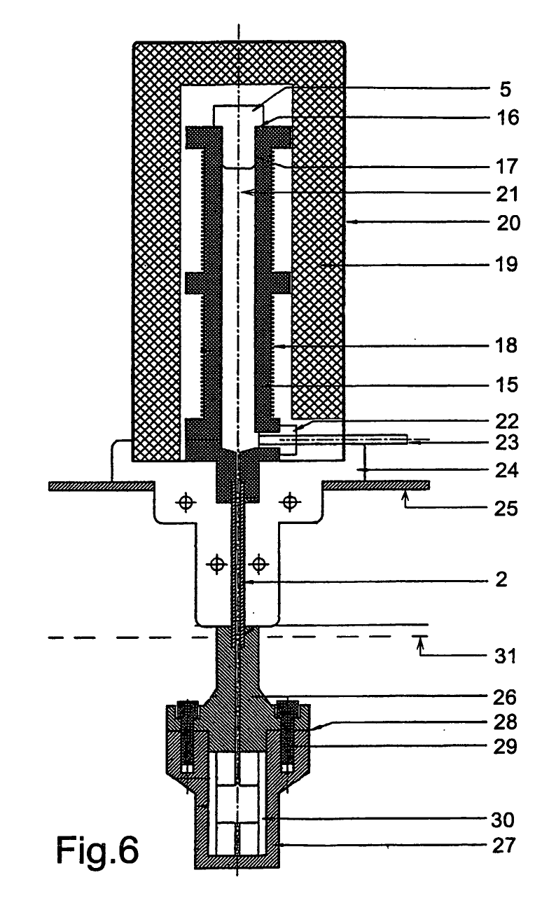

FIG. 6 shows in detail the construction of an apparatus as illustrated in FIG. 3.

In the development stage, the equipment is particularly adapted for measuring chemical shrinkage in dense, hydrating specimens of high quality concrete. The underlying measuring principle is, however, more accurately contained in the title Isochoric Volumeter.

The apparatus is built up with a reference chamber and a test chamber which are mutually connected through a narrow capillary tube. The measuring set-up is schematically represented in FIG. 2. During a measuring operation, the test chamber is submerged in a temperature controlled water bath.

In FIG. 2 is illustrated a schematic reproduction of the isochoric measuring principle in the apparatus. A liquid filled reference chamber 1 is connected with a test chamber 3 through a narrow capillary tube 2. During a measuring operation, the pressure is kept constant in the entire system by controlling the temperature of the reference volume. If a change in volume occurs in the test chamber 3, this will imply a simultaneous change in temperature in the reference chamber 1. The system is very “rigid”; a temperature change of 1° C. in the reference chamber 1 thus induces a rise in pressure of 4-5 bar in the system. This means that an isobar, pressure actuated temperature control of the reference chamber 1 is very well-defined. The isochoric volume dosing which is determined by thermal volumetric expansion of the carrying medium is therefore very precise. With a relatively simple technique, dosing with continuous measurement with a resolution limit of 1-10 nl corresponding to 0.001-0.01 mm³ may be attained.

The reference chamber consists of an elongated copper cylinder 15 with a connected pressure transducer 5, see FIG. 4. At the outer side of the copper cylinder there is arranged a heating element 4, e.g. in the shape of a plastic film mounted on a bifilarly winded resistance wire, enabling a precise, separate control of the temperature of the unit.

During a measuring operation, see e.g. FIG. 5, where the chemical shrinkage in ml per 100 g cement (Swedish low alkaline, sulphate-resisting cement) is depicted, a constant pressure in the system is maintained by controlling the temperature of the reference chamber 1. A volume reduction in the test chamber is therefore reflected through a temperature increase in the reference chamber, and vice versa. Detection of even very small volume changes of the specimen 6 in the test chamber 3 is thereby converted to a simple temperature measurement in the reference chamber 1. In the developed prototype of the equipment there is used programmable CR10X data logger/control unit for performing the measuring operation.

The described system is very “rigid”; with water as carrier medium, a temperature change of 1° C. in the reference chamber 1 thus induces a rise in pressure of 4-5 bar in the system, depending on the temperature level. An isobar, pressure actuated temperature control of the reference chamber 1 is therefore very well-defined. Consequently, this implies that a isochoric volumetric dosing determined by thermal volumetric expansion of the carrier medium becomes extraordinarily precise. With traditional technique, one may continuously measure/control volumes with a resolution limit of 10 nl corresponding to 0.01 mm³.

The measuring system is, of course, not strictly isochoric (constant volume) as a temperature change will affect the volume of the reference chamber itself; this effect, which is corrected by calculation, however only constitutes about 3% of the volume change of the carrier medium.

### Prototype of Volumeter

As part of the work with examining the hydrating kinetics of Portland cements, a prototype of the apparatus has been developed, made and tested, see FIG. 3. In connection with the current research, there are additionally four volumeters under manufacture at the moment. The geometrical and structural form of the apparatus appears from FIG. 6 that shows the apparatus largely in the scale 1:1. The volumeter shown in FIG. 3 is particularly adapted to examinations of binder phases in dense high quality concretes.

FIG. 3 illustrates the structure of an apparatus according to the invention. The same means have the same reference numbers in all Figures. At the top is seen the insulating jacket 7 surrounding the reference chamber 1. At the bottom is seen the test chamber 3 developed for measuring chemical shrinkage in dense, hardening cement paste. Reference chamber 1 and test chamber 3 are connected with a capillary tube which is passed through a collar 8 of POM (polyoxymethylene plastic) for suspending the volumeter in a thermostatically controlled bath. At the centre, to the left, is seen a capillary evacuation and filling tube 9. Before measurement, the chambers are evacuated and flushed with saturated steam so that they are free from air. The system is then filled with airless water at the operating pressure applied. By cutting the capillary tube with a special tong, cold welding occurs, ensuring absolute tightness.

The equipment shown is adapted for isobar measurement of chemical shrinkage at up to 10 bar system pressure. The volume of the reference chamber, about 3.5 ml, is adapted to measuring chemical shrinkage in specimens 6 of 0.5-2 g of Portland cement. The temperature range of the reference chamber 1 during measurement will typically be in the range 25-65° C. For the prototype of the volumeter shown here, the resolution limit is about 10 nl (0.01 mm³).

The “heart” of the volumeter, the reference chamber 1, is shown exposed in FIG. 4, i.e. the insulating jacket 7 is removed. By shaping the reference chamber 1, the volumeter may be adapted to specific measuring tasks with regard to: Measuring range, pressure level, resolution limit and time constant. The reference chamber 1 shown here is therefore only an example of adapting a chamber to a certain measuring task.

The reference chamber 1 is made of copper, the high heat conduction ability of this metal ensures a uniform temperature distribution in the chamber. At the top of the chamber 1 there is mounted a pressure transducer 5 with a measuring range up to 12.5 bar. At the surface of the reference chamber is seen winding grooves for bifilarly winded heating wire of kanthal which is used for controlling the temperature of the reference chamber.

The chamber, which has a volume of about 3.5 ml, is made of copper in order to ensure a homogenous temperature distribution in the carrier medium. At the top of the reference chamber is seen the built-in pressure transducer. In the copper block thermo-elements are embedded for measuring the temperature of the block/carrier medium. On the surface of the reference chamber is mounted a bifilarly winded heating wire of diameter 0.2 mm kanthal. The reference chamber shown is designed for a working pressure up to 10 bar. During a measuring operation, constant pressure is maintained in the reference chamber. The system is very “rigid”—an increase in temperature of 1° C. in the reference chamber induces a rise in pressure of 4-5 bar in the system. An isobar, pressure actuated control of the temperature of the reference chamber therefore enables a very precise, isochoric volumetric dosing determined by thermal volumetric expansion of the carrier medium.

In FIG. 6 is illustrated a cross-section through an apparatus according to the invention. The pressure transducer 5 may be of the type PX600-200 GV. The pressure transducer 5 has been screwed into the copper cylinder 15 by means of thread 17. Between the transducer 5 and the cylinder 15 there is provided a flange gasket 16, e.g. made of PTFE.

Around the cylinder 15 is arranged a heating body 4, e.g. in the form of a kanthal resistance wire 18 with a characteristic value of 16.1 Ohm/m, in the actual example resulting in a total resistance of about 48 Ohm, corresponding to about 3 m of wire.

Around the cylinder 15 and heating body 4 there is arranged an insulated jacket 7 which is made up of e.g. PUR foam 19, surrounded by an aluminium jacket 20.

The interior 21 of the cylinder 15 is filled with expansion liquid and is connected via a socket 22 and a gasket to a connecting tube 23 having a diameter of 2 mm.

The above described means together constitute the reference chamber 1. This has been mounted on a support ring 24 which can comprise a collar 25 for suspending the entire apparatus in the test set-up.

The reference chamber 1 is connected via a capillary tube 2, in this embodiment a stainless steel tube, to the test chamber 3.

The test chamber 3 is built up of two stainless steel halves 26, 27, which are assembled with a PTFE gasket 28 by means of stainless steel bolts 29. Inside the chamber 3, the specimen may be arranged in a specimen holder 30 made of bronze.

When measurements are performed, the test chamber 3 is submerged in a thermostatically controlled bath. The surface is illustrated by 31.

In a preferred embodiment, the apparatus according to the invention is thus characterised in:
that a liquid filled test chamber 3 with volume Vp and a liquid filled reference chamber 1 with volume Vc are mutually connected by a narrow capillary tube 2 so that the pressure p is the same in the test chamber 3 and reference chamber 1;
that the volumeter may contain the same liquid phase in test chamber 3 as well as in reference chamber 1;
that the test chamber 3 may be separated from the reference chamber 1 by a yielding membrane (not shown) so that test chamber 3 and reference chamber 1 may contain different liquid phases with the same pressure;
that the pressure p in test chamber 3 and reference chamber 1 may be maintained at a constant value through controlling the reference chamber temperature 0, e.g. by electric heating or cooling of the reference chamber;
that the pressure p in test chamber 3 and reference chamber 1 may be changed in a pre-selected way by changing the temperature of the reference chamber, e.g. by electric heating or cooling of the reference chamber;
that even very small changes in volume in the test chamber 3, e.g. in connection with physical, physical/chemical or chemical processes, phase transformations or reactions in the test chamber, may be detected continually with great accuracy by simple measurement of temperature changes in the reference chamber;
that even very small and slow volumetric flows from the surroundings to the test chamber or vice versa, e.g. in connection with studies of osmotic phenomena or by measuring the permeability of materials, may be detected continuously with great accuracy by simple measurement of the temperature changes in the reference chamber;
that the measuring range, pressure level, resolution limit and time constant of the volumeter may be adapted to a number of very different measuring tasks and applications by choosing the volume Vp of the test chamber, the volume Ve of the reference chamber, the shape of the reference chamber and by choosing the measuring range of pressure transducer.

The measuring technique is primarily intended for performing research, development and control tasks in university and industrial laboratories.

The application potential should maybe be considered for a modular measuring system, where only a few standardised reference chambers may freely be combined with a number of test chambers that are adapted to specific measuring tasks, e.g. measuring chemical reaction processes, measuring the permeability of tight materials, or measuring ice formation processes in freezing, porous materials etc.

By this system structure, the invention will find application within a pretty wide market area with a measurable program of products.

With the research field of “physics and chemistry of cement bonded materials”, there are a number of examples of tests which become possible and may be performed with greater accuracy. As a few selected examples hereof may be mentioned:
The isochoric volumeter enables accurate measurement of chemical shrinkage and thereby surveying hydration kinetics in dense binder phases of high quality concrete; this will have great significance for research as rapid development takes place within the area in these years;
The isochoric volumeter is expected to enable a near differential measurement of activation energy in hardening cement systems containing micro silica; this will be of great interest to research as well as in practise as prediction of the influence of temperature on the hardening development of concrete forms part of all software programs used today for calculating temperature development, maturity development and temperature stresses in hardening concrete constructions. The need for these measurements is particularly urgent for high quality concretes as the activation energy of the puzzolano reaction of micro silica deviates markedly from the activation energy of the other reactants in the system;
Through simple adaptation of the test chamber, the isochoric volumeter may be used for accurate examination of ice formation in salt containing, freezing cement pastes; this area is of great significance for the on-going durability research, where frost decomposition of salt-exposed concretes constitutes an essential practical problem;
The isochoric volumeter may be used for determining the permeability properties of binder phases in high quality concretes; with the techniques used presently there are no suitable methods for determining the permeability of very dense binder phases. Examination of this kind has inter alia significance for the work with fire resistance of high quality concretes where so-called explosive scaling has appeared to be a serious problem;
The test chamber of the isochoric volumeter may be designed so that it constitutes the measuring chamber in a high precision, isothermal calorimeter, e.g. SETARAM Calvet MS 80. Hereby, one will have the possibility of simultaneous determination of reaction enthalpy and chemical shrinkage in hydrating cement systems; compared with the methods used presently, this will provide completely new possibilities for the hydration research.

1. A method for continuous measurement of volume changes in materials that are subjected to physical, physical-chemical and/or chemical reactions with an apparatus including a test chamber and a reference chamber, the chambers being mutually connected, and wherein means for detecting the pressure in a liquid placed in the reference chamber is provided in the reference chamber, and means for temperature regulation and temperature detection are furthermore provided in the reference chamber, wherein the pressures in the reference chamber and the test chamber are known, wherein the temperature is measured in a reference liquid contained in the reference chamber, and wherein temperature changes of the reference liquid in the reference chamber are correlated with corresponding volume changes of a specimen contained in the test chamber.

2. A method for continuous measurement of volume flow rates from or to materials that are subjected to physical, physical-chemical and/or chemical reactions with an apparatus including a test chamber and a reference chamber, the chambers being mutually connected, and wherein means for detecting the pressure in a liquid placed in the reference chamber is provided in the reference chamber, and means for temperature regulation and temperature detection in the liquid placed in the reference chamber are furthermore provided, wherein the pressures in the reference chamber and the test chamber are known, wherein the temperature is measured in a reference liquid contained in the reference chamber, and wherein temperature changes of the reference liquid in the reference chamber are correlated with corresponding volume flow rates of a specimen liquid between a test chamber and the surroundings for the test chamber, and wherein the specimen liquid is contained in the test chamber and/or the surroundings.

3. A method according to claim 2, wherein the volume flow rates are of one or more of the following types of flow: laminar flow, turbulent flow, capillary flow, diffusion, and/or osmosis.

4. A method according to claim 1, wherein the pressure in the reference chamber and in the test chamber are maintained at one and the same level, wherein the pressure in the reference chamber and in the test chamber is regulated by regulating the temperature in the reference chamber, and wherein a change in volume of a specimen in the test chamber is reflected by a change in temperature in the reference chamber so that a reduction in volume of the specimen in the test chamber is reflected in a rise in temperature in the reference chamber, and an increased volume of the specimen in the test chamber is reflected in a drop of temperature in the reference chamber.

5. A method according to claim 2 wherein the pressure in the reference chamber and the test chamber are maintained at one and the same level, wherein the pressure in the reference chamber and in the test chamber is regulated by regulating the temperature of the liquid in the reference chamber, and wherein a volume flow rate of specimen liquid to or from the test chamber is reflected in a change in temperature in the test chamber so that a volume flow rate of specimen liquid in the test chamber is reflected in a rise in temperature in the reference chamber, and a volume flow rate of specimen liquid to the test chamber is reflected in a drop of temperature in the reference chamber.

6. An apparatus for continuous measurement of volume flow rates or volume changes in materials that undergo physical, physical-chemical and/or chemical reactions, wherein the apparatus includes a test chamber and a reference chamber that are mutually connected, wherein a specimen is arranged in the test chamber during measurements, and test chamber, reference chamber and their mutual connection are filled with a liquid, and where wherein the pressure in the test chamber during measurements is the same as the pressure in the reference chamber, wherein the reference chamber is provided with a pressure transducer for measuring the pressure in the reference chamber, and wherein the reference chamber is also provided with a temperature regulator intended for regulating the temperature of the liquid in the reference chamber, and wherein the reference chamber is also provided with means for detecting temperature changes in the liquid in the reference chamber.

7. An apparatus according to claim 6, wherein test chamber and the reference chamber are mutually connected with a tube, preferably a capillary tube, so that a largely thermal separation of the liquid in the reference chamber and in the test chamber is achieved, and so that a pressure connection between the reference chamber and the test chamber is ensured.

8. An apparatus according to claim 6 wherein the pressure in the test chamber and in the reference chamber, respectively, are regulated by changing the temperature of the liquid in the reference chamber.

9. An apparatus according to claim 6, wherein the specimen liquid in the test chamber is the same liquid as the reference liquid in the reference chamber, and wherein the liquids have the possibility of pressure equalization between the specimen liquid and the reference liquid, and wherein the liquids also have the possibility of exchanging the liquids between the test chamber and the reference chamber, respectively.

10. An apparatus according to claim 6, wherein the specimen liquid in the test chamber is different from the reference liquid in the reference chamber, and wherein there is the possibility of pressure equalization between the specimen liquid and the reference liquid, though means have been arranged for preventing mixing of the liquids in the test chamber and the reference chamber, respectively.

11. An apparatus according to claim 9 wherein a membrane is provided between the liquids in the test chamber and the reference chamber, respectively, wherein the membrane has a flexibility that ensures sufficient possibility for pressure equalisation between the liquids in the test chamber and the reference chamber, and wherein the membrane also has a tightness that ensures sufficient prevention of mixing the liquid in the test chamber and the reference chamber, respectively.

12. An apparatus according to claim 6, wherein one or more of the parameters measurement range, pressure level, solubility limit and time constant for the apparatus may be adapted to specific applications of measurement and use by establishing given measures for one or more of the terms: volume of the test chamber, volume of the reference chamber, the shape of the reference chamber, and the measuring range of the pressure transducer.

13. Use of an apparatus according to claim 6 for measuring volume changes by physical and/or chemical and/or physical/chemical reactions, e.g. by measuring chemical shrinkage in cement-based materials, furthermore e.g. for measuring chemical shrinkage in dense binder phases in high-strength concrete, for determining hydrating kinetics in the materials.
